(19) United States
(12) Patent Application Publication
(10) Pub. No.: US 2024/0080378 A1
(43) Pub. Date: Mar. 7, 2024

(54) SYSTEM AND METHOD FOR EXPANSION OF OPEN RADIO ACCESS NETWORK

(71) Applicants: INVENTEC (PUDONG) TECHNOLOGY CORPORATION, Shanghai (CN); INVENTEC CORPORATION, Taipei City (TW)

(72) Inventors: Encheng LIOU, Taipei City (TW); Lien-Feng CHEN, Taipei City (TW); Chang-Han YANG, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 18/123,215

(22) Filed: Mar. 17, 2023

(30) Foreign Application Priority Data
Sep. 6, 2022 (CN) 202211085309.6

(51) Int. Cl. H04L 69/08; H04W 24/02

(52) U.S. Cl. CPC H04L 69/08; H04W 24/02

(57) ABSTRACT

A system for expansion of open radio access network includes a service management and orchestration (SMO) apparatus and a near-real time ran intelligent controller (Near-RT RIC) connected with each other, wherein the SMO apparatus includes a non-real-time ran intelligent controller (Non-RT RIC). Each of the SMO apparatus, the Near-RT RIC and the Non-RT RIC includes a first decoder, and at least one of the SMO apparatus, the Near-RT RIC and the Non-RT RIC includes a second decoder. The first decoder is configured to decode a first packet of a first communication protocol, the second decoder is configured to decode a second packet of a second communication protocol, and the first communication protocol is different from the second communication protocol.

### CROSS-REFERENCE TO RELATED APPLICATIONS

This non-provisional application claims priority under 35 U.S.C. § 119(a) on Patent Application No(s). 202211085309.6 filed in China on Sep. 6, 2022, the entire contents of which are hereby incorporated by reference.

### BACKGROUND

### 1. Technical Field

This disclosure relates to a system and method for expansion of open radio access network.

### 2. Related Art

It has gradually become a mainstream consensus to realize 5G private network with 5G open architecture and apply it in the intelligent factory scenario. The open architecture of 5G mainly follows the interface standards defined by the International Open Radio Access Network Organization (o-RAN), and uses the 5G service management and orchestration system to manage and optimize base stations. In addition, the 5G components and nodes defined by the 3rd Generation Partnership Project (3GPP) standard are also required to follow the standard system architecture or protocol.

However, in the intelligent factory private network application of 5G open architecture, the network components deployed are often not limited to the components defined by the 5G 3GPP standard and the o-RAN standard. Instead, there may be many peripheral network devices and nodes that together form an intelligent factory application scenario. Integrating these network devices in an intelligent factory is often a dilemma, mainly because it is difficult to centrally manage or integrate various network information, resulting in many technical limitations and integration costs. Therefore, the application of 5G private network to intelligent factories slows down the speed of technology development and application implementation, and thus cannot effectively embody the value of intelligent factories and effectively utilize the transmission advantages of 5G transmission technology.

### SUMMARY

Accordingly, this disclosure provides a system and method for expansion of open radio access network to meet the above requirements.

According to one or more embodiment of this disclosure, a system for expansion of open radio access network includes a service management and orchestration apparatus and a near-real-time radio access network intelligent controller, wherein the service management and orchestration apparatus includes a non-real-time radio access network intelligent controller, and the near-real-time radio access network intelligent controller is connected to service management and orchestration apparatus. The service management and orchestration apparatus, the non-real-time radio access network intelligent controller and the near-real-time radio access network intelligent controller each includes a first decoder. At least one of the service management and orchestration apparatus, the non-real-time radio access network intelligent controller and the near-real-time radio access network intelligent controller includes a second decoder. The first decoder is configured to decode a first packet of a first communication protocol, and the second decoder is configured to decode a second packet of a second communication protocol, and the first communication protocol is different from the second communication protocol.

According to one or more embodiment of this disclosure, a method for expansion of open radio access network includes installing a first decoder on each of a service management and orchestration apparatus, a non-real-time radio access network intelligent controller and a near-real-time radio access network intelligent controller; and installing a second decoder on at least one of the service management and orchestration apparatus, the non-real-time radio access network intelligent controller and the near-real-time radio access network intelligent controller, wherein the first decoder is configured to decode a first packet of a first communication protocol, the second decoder is configured to decode a second packet of a second communication protocol, and the first communication protocol is different from the second communication protocol.

In view of the above description, according to the system and method for expansion of open radio access network of one or more embodiment of this disclosure, it may reduce the development and maintenance costs of developing the intermediary layer in the rest of the hardware for the overall 5G private network, then further integrate the data transmitted by the expanded module with the data of the apparatus and/or controller in the 5G open radio access network, realize the goal and purpose of 5G open radio access network system with multiple communication interfaces and centralized management, and can integrate all communication devices around the intelligent factory. Also, with the communication protocol compatibility technology that can be realized through the present disclosure, the 5G private network management system may support the system management framework with other communication protocols in addition to base station apparatus that merely supports the open radio access network interface.

The above description of the disclosure and the following description of the implementation are used to demonstrate and explain the spirit and principle of the present invention, and provide a further explanation of the scope of claim of the present invention.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of the system for expansion of open radio access network according to an embodiment of the present disclosure;

FIG. 2 is a flow chart of the method for expansion of open radio access network according to an embodiment of the present disclosure;

FIG. 3 is a block diagram of the system for expansion of open radio access network according to another embodiment of the present disclosure; and

FIG. 4 is a flow chart of the method for implementing and applying a second decoder according to still another embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

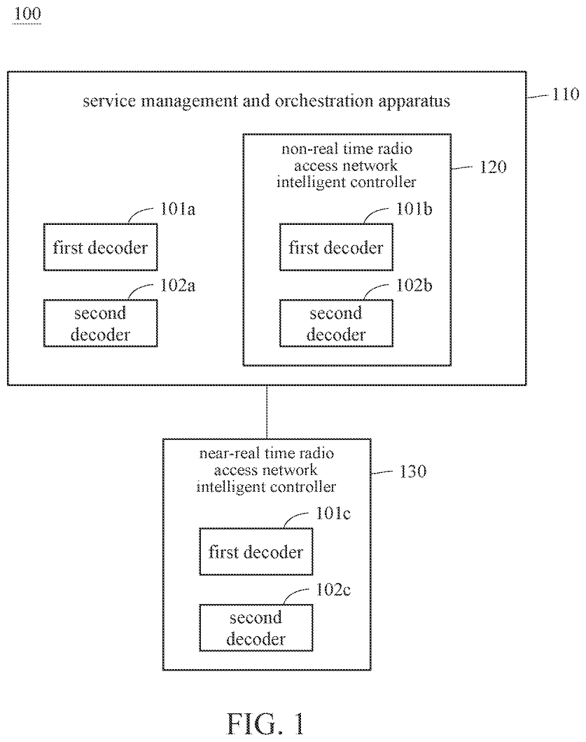

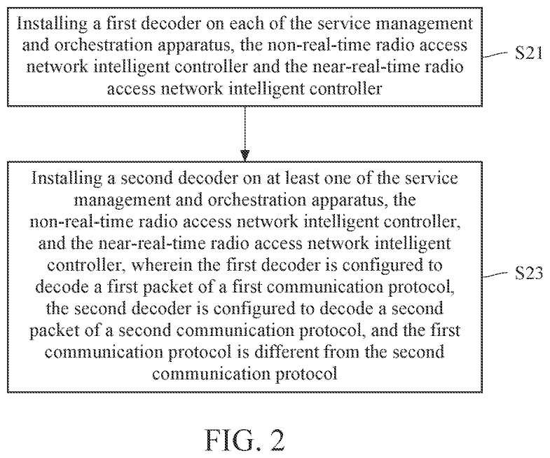

Please refer to FIG. 1 along with FIG. 2, wherein FIG. 1 is a block diagram of the system for expansion of open radio access network (o-RAN) according to an embodiment of the present disclosure, and FIG. 2 is a flow chart of the method for expansion of open radio access network according to an embodiment of the present disclosure. As shown in FIG. 1, the system for expansion of open radio access network 100 (referred to as “the system 100” in the following descriptions) includes a service management and orchestration (SMO) apparatus 110 and a near-real-time radio access network intelligent controller (Near-RT RIC) 130, and the service management and orchestration apparatus 110 includes a non-real-time radio access network intelligent controller (Non-RT RIC) 120. The near-real-time radio access network intelligent controller 130 is connected to service management and orchestration apparatus 110.

As shown in FIG. 2, the method for expansion of open radio access network includes: step S21: installing a first decoder on each of the service management and orchestration apparatus, the non-real-time radio access network intelligent controller and the near-real-time radio access network intelligent controller; and step S23: installing a second decoder on at least one of the service management and orchestration apparatus, the non-real-time radio access network intelligent controller, and the near-real-time radio access network intelligent controller. Each of the steps in the above-mentioned embodiments may be executed by setting one or more computer apparatuses.

In step S21, the first decoder 101a is installed on the service management and orchestration apparatus 110, the first decoder 101b is installed on the non-real-time radio access network intelligent controller 120, and the first decoder 101c is installed on the near-real-time radio access network intelligent controller 130. For example, the service management and orchestration apparatus 110 installs the first decoder 101a therein, the non-real-time radio access network intelligent controller 120 installs the first decoder 101b therein, and the near-real-time radio access network intelligent controller 130 installs the first decoder 101c therein.

In step S23, the second decoder is installed on at least one of the service management and orchestration apparatus 110, the non-real-time radio access network intelligent controller 120, and the near-real-time radio access network intelligent controller 130. For example, the service management and orchestration apparatus 110 installs the second decoder 102a therein, and/or the non-real-time radio access network intelligent controller 120 installs the second decoder 102b therein, and/or the near-real-time radio access network intelligent controller 130 installs the first decoder 101c therein. In other words, the service management and orchestration apparatus 110, the non-real-time radio access network intelligent controller 120, and the near-real-time radio access network intelligent controller 130 may include the second decoder 102a, the second decoder 102b, and the second decoder 102c, respectively. Or, one or two of the service management and orchestration apparatus 110, the non-real-time radio access network intelligent controller 120 and the near-real-time radio access network intelligent controller 130 may include the corresponding second decoder.

For example, in order to achieve the purpose of expanding the open radio access network in the simplest and intuitive way, the service management and orchestration apparatus 110 may install the second decoder 102a therein, and the second decoder 102a is installed outside the non-instant radio access network intelligent controller 120. In order to avoid information security problems due to excessive authority of the communication device supporting the second communication protocol, the non-real-time radio access network intelligent controller 120 may install the second decoder 102b therein, and/or the near real-time radio access network intelligent controller 130 may install the second decoder 102c therein.

The first decoders 101a, 101b and 101c are configured to decode the first packet of the first communication protocol, and the second decoders 102a, 102b and 102c are configured to decode the second packet of the second communication protocol. The first communication protocol and the second communication protocol are different from each other. For example, the first protocol can be open radio access network, and the second communication protocol may include one or more of TR069 protocol, Secure Shell (SSH) protocol, Message Queuing Telemetry Transport (MQTT) protocol, Representational State Transfer Application Programming Interface (RESTful API) protocol, Telnet protocol, Remote Desktop Protocol (RDP), Internet Security Protocol (IPsec) and Virtual Private Network (VPN).

In other words, each of the service management and orchestration apparatus 110, the non-real-time RAN intelligent controller 120 and the near-real-time radio access network intelligent controller 130 may include a plurality of second decoders for implementing different communication protocols. In addition, when at least two of the service management and orchestration apparatus 110, the non-real-time radio access network intelligent controller 120 and the near-real-time radio access network intelligent controller 130 need to communicate with a specific second communication protocol, the two are preferably equipped with a second decoder supporting the specific second communication protocol.

Accordingly, through the system and method for expansion of open radio access network, it may reduce the development and maintenance costs of developing the intermediary layer in the rest of the hardware for the overall 5G private network, then further integrate the data transmitted by the expanded module with the data of the apparatus and/or controller in the 5G open radio access network, realize the goal and purpose of 5G open radio access network system with multiple communication interfaces and centralized management, and can integrate all communication devices around the intelligent factory.

In addition, in the embodiment in which the second decoder 102b is installed on the non-real-time radio access network intelligent controller 120, the first application may be installed on the non-real-time radio access network intelligent controller 120 first, and then the first application is served as the second decoder 102b, wherein the first application is, for example, rAPP.

Further, in this embodiment, the first application should be installed within the non-real-time radio access network intelligent controller 120, and the non-real-time radio access network intelligent controller 120 may not include other components for translation, transformation and decoding.

In addition, in the embodiment in which the second decoder 102c is installed on the near-real-time radio access network intelligent controller 130, the second application may be installed on the near-real-time radio access network intelligent controller 130 first, and then the second application is served as the second decoder 102c, wherein the second application is, for example, xAPP.

Further, in this embodiment, the information from the apparatus of the second communication protocol may be obtained in a shorter time, and the second application may communicate with other applications that are also xAPP in real time to quickly issue the corresponding management decisions.

It should be noted that, the method for expanding the open radio access network may include the embodiments of installing the first application on the non-real-time radio access network intelligent controller 120 and installing the second application on the near-real-time radio access network intelligent controller 130, and may also include only one of them, which is not limited by the present disclosure. Each of the steps in the above-mentioned embodiments may be executed by setting one or more computer apparatuses.

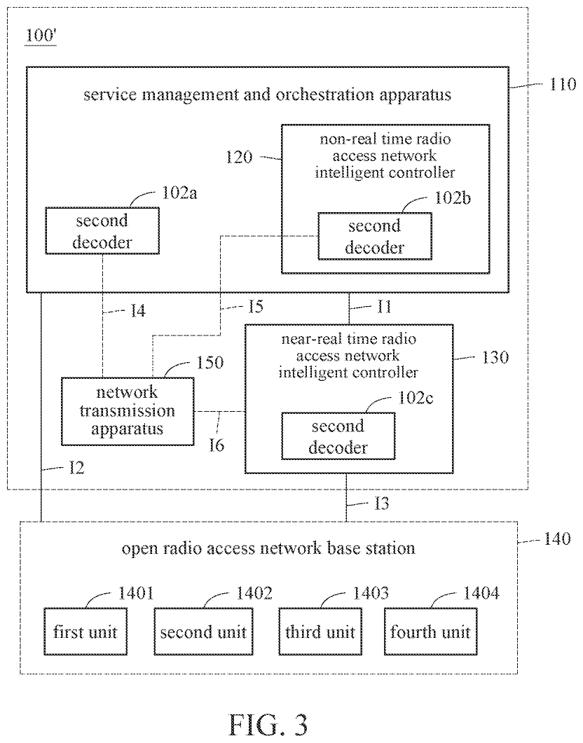

Please refer to FIG. 3 which is a block diagram of the system for expansion of open radio access network according to another embodiment of the present disclosure. For simplicity of description, the first decoder is not shown in FIG. 3. However, the service management and orchestration apparatus 110, the non-real-time radio access network intelligent controller 120 and the near-real-time radio access network intelligent controller 130 of the system for expansion of open radio access network 100′ (referred to as “the system 100′” in the following descriptions) shown in FIG. 3 are same as the service management and orchestration apparatus 110, the non-real-time radio access network intelligent controller 120 and the near real-time radio access network intelligent controller 130 of the system 100 shown in FIG. 1, and the repeated descriptions are omitted herein.

First, as shown in FIG. 3, the service management and orchestration apparatus 110 and the near real-time radio access network intelligent controller 130 may be directly connected to the open radio access network base station 140, and the non-real-time radio access network intelligent controller 120 may be indirectly connected to the open radio access network base station 140. The open radio access network base station 140 supports the first communication protocol. Specifically, the open radio access network base station 140 may include a first unit 1401, a second unit 1402, a third unit 1403 and a fourth unit 1404. The first unit 1401 may be a base station (gNB/eNB), the second unit 1402 may be a radio unit (RU), the third unit 1403 may be a distributed unit (DU), and the fourth unit 1404 may be a central unit (CU).

In the embodiment shown in FIG. 3, the system 100′ further includes a network transmission apparatus 150, that is, the method for expansion of the open radio access network may further include connecting the network transmission apparatus 150 to at least one of the service management and orchestration apparatus 110, non-real-time radio access network intelligent controller 120 and the near-real-time radio access network intelligent controller 130, especially in a wired way, wherein the “at least one” refers to the apparatus/controller installed with the second decoder. The network transmission apparatus 150 may be an apparatus supporting the second communication protocol, so as to communicate based on the second communication protocol. For example, the network transmission apparatus 150 may be one or more of a base station (gNB/eNB), a radio unit (RU), a distribution unit (DU) and a central unit (CU).

Specifically, the service management and orchestration apparatus 110 may be connected to the near-real-time radio access network intelligent controller 130 through the first interface Il, and the first decoder of the service management and orchestration apparatus 110 may be connected to the open radio access network base station 140 through the second interface I2; and the first decoder of the near-real-time radio access network intelligent controller 130 may be connected to the open radio access network base station 140 through the third interface I3. The first interface I1 may be the A1 interface of the open radio access network, and is configured for communication between the non-real-time radio access network intelligent controller 120 and the near-real-time radio access network intelligent controller 130; the second interface I2 may be the O1 interface of the open radio access network, such as a fault, configuration, audit, performance, security (FCAPS) control interface; and the third interface I3 may be the E2 interface (node) of the open radio access network, and is configured for communication between the near-real-time radio access network intelligent controller 130 and the base station.

In other words, the second decoder 102b may perform data transmission with the second decoder 102c of the near-real-time radio access network intelligent controller 130 through the existing A1 interface (first interface I1).

In addition, the second decoder 102a of the service management and orchestration apparatus 110 may be connected to the network transmission apparatus 150 through the fourth interface I4; the second decoder 102b of the non-real-time radio access network intelligent controller 120 may be connected to the network transmission apparatus 150 through the fifth interface I5; and the second decoder 102c of the near-real-time radio access network intelligent controller 130 may be connected to the network transmission apparatus 150 through the sixth interface I6, wherein the fourth interface I4, the fifth interface I5 and the sixth interface I6 are all interfaces supporting the second communication protocol.

In other words, the first package that the open radio access network base station 140 outputs to one or more of the service management and orchestration apparatus 110, the non-real-time radio access network intelligent controller 120 and the near-real-time radio access network intelligent controller 130 may be analyzed by the first decoder; and the second package that the network transmission apparatus 150 outputs to one or more of the service management and orchestration apparatus 110, the non-real-time radio access network intelligent controller 120 and the near-real-time radio access network intelligent controller 130 may be analyzed by the second decoder.

Accordingly, the network transmission apparatus 150 supporting the second communication protocol may further transmit the message based on the second communication protocol to one or more of the service management and orchestration apparatus 110, the non-real-time radio access network intelligent controller 120 and the near-real-time radio access network intelligent controllers 130.

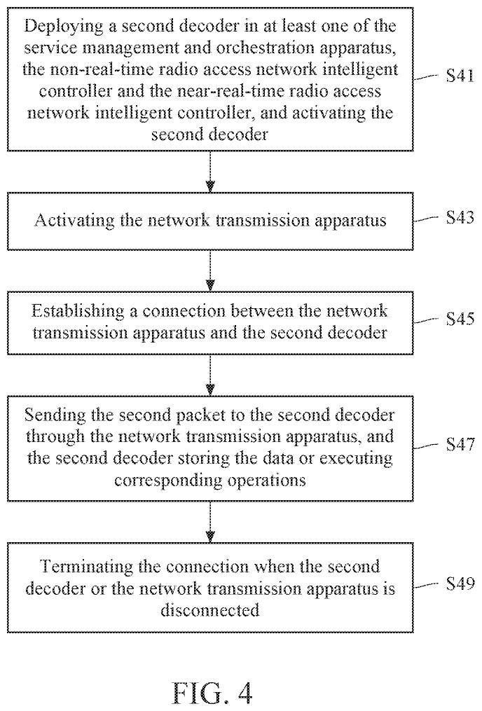

Please refer to FIG. 4 along with FIG. 3, wherein FIG. 4 is a flow chart of the method for implementing and applying a second decoder according to still another embodiment of the present disclosure. As shown in FIG. 4, the method for implementing and applying the second decoder includes: step S41: deploying a second decoder in at least one of the service management and orchestration apparatus, the non-real-time radio access network intelligent controller and the near-real-time radio access network intelligent controller, and activating the second decoder; step S43: activating the network transmission apparatus; step S45: establishing a connection between the network transmission apparatus and the second decoder; step S47: sending the second packet to the second decoder through the network transmission apparatus, and the second decoder storing the data or executing corresponding operations; and step S49: terminating the connection when the second decoder or the network transmission apparatus is disconnected.

In step S41, the second decoder is installed on at least one of the service management and orchestration apparatus 110, the non-real-time radio access network intelligent controller 120 and the near-real-time radio access network intelligent controller 130, and the second decoder is activated. The way to install the second decoder may be the same as step S21 in FIG. 2, the above-mentioned first application and/or the above-mentioned second application, and the repeated descriptions are omitted herein. For the convenience of explanation, the near-real-time radio access network intelligent controllers 130 below is assumed to be installed with the second decoder 102c.

In steps S43 and S45, the network transmission apparatus 150 is activated, and the connection between the network transmission apparatus 150 and the second decoder 102c is established by the network transmission apparatus 150 and the second decoder 102c, wherein the network transmission apparatus 150 and the second decoder 102c are connected through the fifth interface I5. In step S47, the network transmission apparatus 150 may receive the second packet from the terminal device, and transmit the second packet to the second decoder 102c, and the second decoder 102c may execute the corresponding operation, for example, decoding the second packet and/or storing the second packet, etc. In step S49, when the near-real-time radio access network intelligent controller 130 and/or the network transmission apparatus 150 detects that the second decoder 102c or the network transmission apparatus 150 is disconnected, the connection between the second decoder 102c and the network transmission equipment 150 is terminated. In other words, the near-real-time radio access network intelligent controller 130 and/or the network transmission apparatus 150 may detect the connection status of the second decoder 102c and the network transmission apparatus 150 at fixed or non-fixed time intervals after the second decoder 102c and the network transmission apparatus 150 are activated, and terminate the connection between the second decoder 102c and the network transmission apparatus 150 when detecting the disconnection of at least one of the second decoder 102c and the network transmission apparatus 150.

In view of the above description, according to the system and method for expansion of open radio access network of one or more embodiment of this disclosure, it may reduce the development and maintenance costs of developing the intermediary layer in the rest of the hardware for the overall 5G private network, then further integrate the data transmitted by the expanded module with the data of the apparatus and/or controller in the 5G open radio access network, realize the goal and purpose of 5G open radio access network system with multiple communication interfaces and centralized management, and can integrate all communication devices around the intelligent factory. In addition, according to the system and method for expansion of open radio access network of one or more embodiment of this disclosure, the 5G private network may be plugged in and managed in the form of software modules (xAPP, rAPP) to solve the problem when the existing communication equipment does not support a specific communication protocol, and improve the control and management performance of the 5G private network management system. Also, with the communication protocol compatibility technology that can be realized through the present disclosure, the 5G private network management system may support the system management framework with other communication protocols in addition to base station apparatus that merely supports the open radio access network interface.

What is claimed is:

1. A system for expansion of open radio access network comprising:
a service management and orchestration apparatus comprising a non-real-time radio access network intelligent controller; and
a near-real-time radio access network intelligent controller connected to the service management and orchestration apparatus,
wherein the service management and orchestration apparatus, the non-real-time radio access network intelligent controller and the near-real-time radio access network intelligent controller each comprises a first decoder, and at least one of the service management and orchestration apparatus, the non-real-time radio access network intelligent controller and the near-real-time radio access network intelligent controller comprises a second decoder,
wherein the first decoder is configured to decode a first packet of a first communication protocol, and the second decoder is configured to decode a second packet of a second communication protocol, and the first communication protocol is different from the second communication protocol.

2. The system for expansion of open radio access network of claim 1, further comprising a network transmission apparatus for communicating based on the second communication protocol.

3. The system for expansion of open radio access network of claim 1, wherein the service management and orchestration apparatus comprises the second decoder, and the second decoder is installed outside the non-real-time radio access network intelligent controller.

4. The system for expansion of open radio access network of claim 2, wherein the non-real-time radio access network intelligent controller comprises a first application, and the first application is configured to execute the second decoder.

5. The system for expansion of open radio access network of claim 2, wherein the near-real-time radio access network intelligent controller comprises a second application, and the second application is configured to execute the second decoder.

6. A method for expansion of open radio access network comprising:
installing a first decoder on each of a service management and orchestration apparatus, a non-real-time radio access network intelligent controller and a near-real-time radio access network intelligent controller; and
installing a second decoder on at least one of the service management and orchestration apparatus, the non-real-time radio access network intelligent controller and the near-real-time radio access network intelligent controller,
wherein the first decoder is configured to decode a first packet of a first communication protocol, and the second decoder is configured to decode a second packet of a second communication protocol, and the first communication protocol is different from the second communication protocol.

7. The method for expansion of open radio access network of claim 6, further comprising connecting a network transmission apparatus for communicating based on the second communication protocol to the at least one of the service management and orchestration apparatus, the non-real-time radio access network intelligent controller and the near-real-time radio access network intelligent controller.

8. The method for expansion of open radio access network of claim 6, wherein installing the second decoder on the at least one of the service management and orchestration apparatus, the non-real-time radio access network intelligent controller and the near-real-time radio access network intelligent controller comprises:
installing the second decoder inside the service management and orchestration apparatus and outside the non-real-time radio access network intelligent controller.

9. The method for expansion of open radio access network of claim 7, wherein installing the second decoder on the at least one of the service management and orchestration apparatus, the non-real-time radio access network intelligent controller and the near-real-time radio access network intelligent controller comprises:
installing a first application on the non-real-time radio access network intelligent controller,
wherein the first application is served as the second decoder.

10. The method for expansion of open radio access network of claim 7, wherein installing the second decoder on the at least one of the service management and orchestration apparatus, the non-real-time radio access network intelligent controller and the near-real-time radio access network intelligent controller comprises:
installing a second application on the near-real-time radio access network intelligent controller,
wherein the second application is served as the second decoder.
